(19) United States
(12) Patent Application Publication
(10) Pub. No.: US 2011/0208948 A1
(43) Pub. Date: Aug. 25, 2011

(54) READING TO AND WRITING FROM PERIPHERALS WITH TEMPORALLY SEPARATED REDUNDANT PROCESSOR EXECUTION

(75) Inventors: Richard Knight, Stroud (GB); Neil Hastie, Lydney (GB); Simon Brewerton, Trowbridge (GB); Glenn Farrall, Long Ashton (GB)

(73) Assignee: INFINEON TECHNOLOGIES AG, Neubiberg (DE)

(21) Appl. No.: 12/710,616

(22) Filed: Feb. 23, 2010

(51) Int. Cl. G06F 9/30; G06F 3/00; G06F 15/76; G06F 9/312

(52) U.S. Cl. 712/31; 710/5; 712/225; 712/E09.023; 712/E09.033

(57) ABSTRACT

Embodiments relate to systems and methods for reading from and writing to interface peripherals or other shared resources during robust computation utilizing temporally separated redundant execution. Embodiments can be utilized in safety-relevant applications related to automotive, banking and finance, aerospace, defense, Internet payment, and others.

### TECHNICAL FIELD

The invention relates generally to safety systems and, more particularly, to temporally separated redundant processor instruction execution having applicability in safety critical or high integrity systems.

### BACKGROUND

High integrity software has become commonplace in a variety of wide-ranging applications. For example, many automotive, banking, aerospace, defense, Internet payment, and other applications have critical paths that require validation of safe operation by means of redundancy, diversity or both.

The general approach of guaranteeing safe operation of a critical path is for two algorithms to be computed and the results compared for consistency or plausibility using an independent comparator. Generally, this has been implemented via two different methods. First, on a system with more than one processing channel, identical algorithms can be computed simultaneously, with one algorithm processed on its own processing channel, and the results compared for consistency. Second, on a system that is limited to one active processing channel, two (or more) diverse algorithms can be computed with temporal separation. These results are then cross-checked for consistency or plausibility. For either approach, it is necessary to ensure that the same code execution has exercised the same data in each run.

Problems exist for both of these implementations. Specifically, problems exist with reading and writing from interface peripherals or shared resources. Where physically separate processing units are used, a hardware comparison of read data is possible because the transactions are issued simultaneously. Only one processing unit drives the read bus transaction, and the read data for other redundant processors is monitored or “snooped” from the bus by the redundant processors as it is transferred to the master processor from shared peripherals or memory. Similarly, with write data, only one processing unit is connected to the bus itself, so the write is driven from this processing unit to the actuator control interface. The problem, however, lies in this single transaction at bus level. Because both the read and write commands are only a single transaction at bus level, the redundancy check covers only the processor and not the transfer of read or write data from the sensor subsystem through any intermediate bridges or on-chip communication infrastructures.

By contrast, where a single processing unit is used and the code sequence is repeated to check the processing operation, a straight hardware-to-hardware comparison of read or write data is not possible. The code for the redundant execution must be modified slightly so that the data from a read or write from a shared resource is, on or before first execution, copied into a temporary space in memory. Upon algorithm completion, this temporary value can then be compared to the value of the hardware register, which would contain the redundant run's value. The same limitation as with multiple processors is also applicable here. Because both the read and write commands are only a single transaction at bus level, the redundancy check covers only the processor and not the transfer of read or write data from the sensor subsystem through any intermediate bridges or on-chip communication infrastructures. Further, the requirement that the code sequence must be modified in order to record an initial copy in memory for the subsequent comparison not only creates an additional complication for the programmer but also makes it difficult to ensure that the temporally-separated runs have executed the exact same instructions.

### SUMMARY

Embodiments relate to systems and methods for reading from and writing to peripheral devices. In an embodiment, a method comprises reading data from a peripheral device by a first processor; copying the data to a register; diverting a read attempt of the peripheral device by a second processor to the register; and reading the data from the register by the second processor.

In an embodiment, a method comprises writing data to a peripheral device by a first processor; logging the data write by the first processor by a logger device; attempting to write data to the peripheral device by a second processor; logging the data write by the second processor by the logger device; and decoding the data write by the second processor to a non-output-generating peripheral device.

In an embodiment, a system comprises at least two processors, wherein one of the at least two processors is a master processor; a peripheral device configured to be read from and written to by at least one of the at least two processors; a register configured to copy a data read of the peripheral device by the master processor and provide the data read to another of the at least two processors in response to a diverted peripheral device read attempt by the another of the at least two processors; an access logger configured to log a data write to the peripheral device by the master processor and compare the data write to a data write of another of the at least two processors; and a null response peripheral device configured to receive redirected data writes from the another of the at least two processors.

In an embodiment, a system comprises a processor having a first mode of execution and a second mode of execution; a peripheral device configured to be read from and written to by the processor during the first mode of execution; a register configured to copy a data read of the peripheral device by the processor in the first mode of execution and provide the data read to the processor in the second mode of execution in response to a read request; an access logger configured to log a data write to the peripheral device by the processor in the first mode of execution and compare the data write to a data write of the processor in the second mode of execution; and a null response peripheral device configured to receive redirected data writes from the processor in the second mode of execution.

### BRIEF DESCRIPTION OF THE DRAWINGS

The invention may be more completely understood in consideration of the following detailed description of various embodiments of the invention in connection with the accompanying drawings, in which:

FIG. 1 is a block diagram of a read mode of a multi-processor safety system according to an embodiment.

FIG. 2 is a flowchart related to the embodiment of FIG. 1.

FIG. 3 is a block diagram of a read mode of a single-processor safety system according to an embodiment.

FIG. 4 is a block diagram of a write mode of a multi-processor safety system according to an embodiment.

FIG. 5 is a flowchart related to the embodiment of FIG. 4.

FIG. 6 is a block diagram of a write mode of a single-processor safety system according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Embodiments relate to systems and methods for reading from and writing to interface peripherals or other shared resources during robust computation utilizing temporally separated redundant execution. Embodiments can be utilized in safety-relevant applications related to automotive, banking and finance, aerospace, defense, Internet payment, and others. “Safety” can refer to personal or physical safety, such as in an automotive system, as well as to security contexts, such as in banking and finance systems, among others. Various embodiments have applicability to dual-central processing unit (CPU) or other multi-CPU configurations, while adaptations are also contemplated for single-CPU configurations. Single- or multi-CPU configurations can be integrated in one or more integrated circuits and/or one or more integrated circuit packages in embodiments.

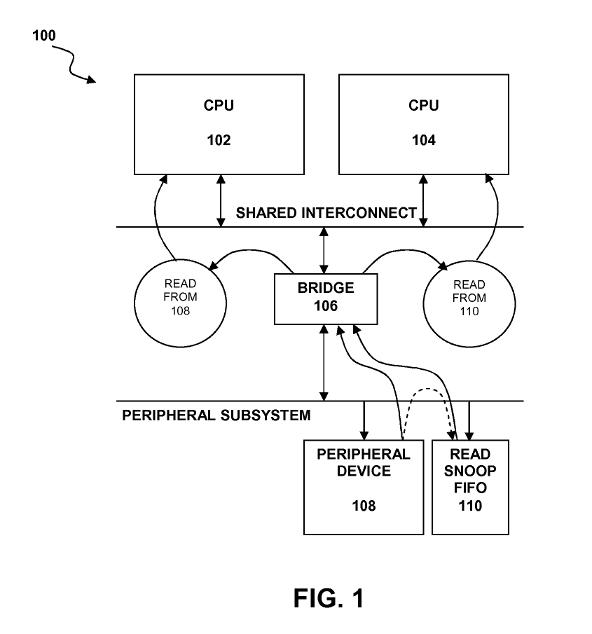

Referring to FIG. 1, a block diagram of a safety system architecture 100 is depicted. System 100 comprises a first CPU 102 and a second CPU 104, though in other embodiments system 100 can be extended to any number of parallel processing units. Additionally, system 100 can also comprise a single CPU, which is described in more detail below. The multi-CPU examples discussed herein will be in the context of a dual-CPU embodiment, as depicted in FIG. 1, without limitation with respect to embodiments having more or fewer CPUs.

CPUs 102 and 104 are coupled via a shared interconnect and a bridge 106 to a peripheral subsystem. The peripheral subsystem comprises one or more peripheral devices 108, such as sensors, memory data structures and others. System 100 is depicted with a single peripheral device 108, though other embodiments can comprise additional and/or varied peripheral devices 108.

System 100 also comprises a read snoop first in first out (FIFO) device 110 in an embodiment. In operation, CPUs 102 and 104 execute identical code sequences. In an embodiment, however, CPU 104 generates separate bus transactions to peripheral device 108. An access logger component of peripheral device 108 records these transactions, and FIFO 110 provides the capability to ensure that read data from the peripheral subsystem to CPUs 102 and 104 is identical when the read data reaches the processor(s).

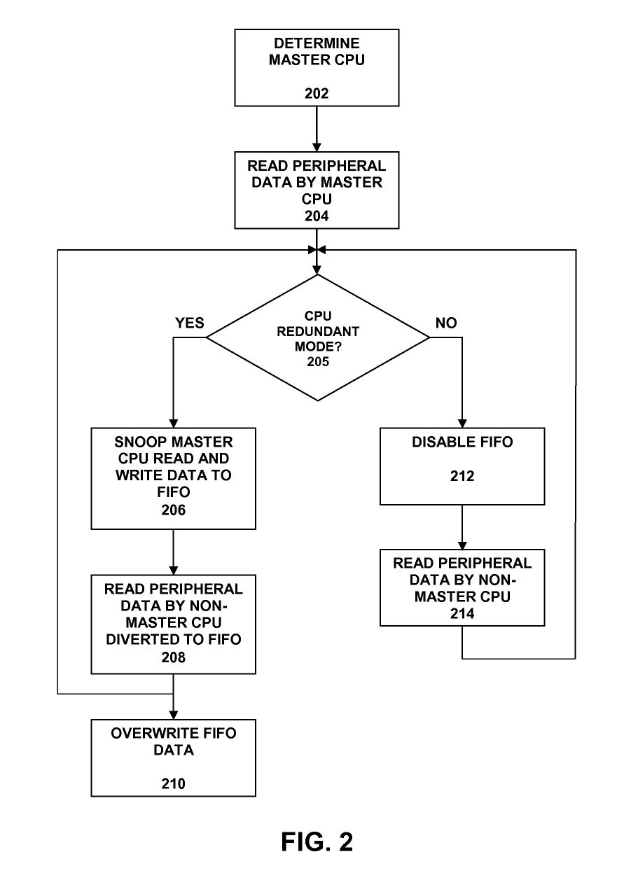

Referring also to FIG. 2, it is desired that the processing sequences (i.e., instructions, read and write data) are identical for each redundant execution by CPU 102 and CPU 104 to ensure safe execution and operation. Unlike conventional lock-step approaches, however, embodiments enable instruction executions to be separated in time. At 202, each CPU 102 and 104 compares its program counter with the program counter(s) of the other CPUs in system 100 to determine which CPU 102 or 104 is the first to execute a particular read transaction. The first processor is then designated as the “master processor” in the program sequence. For purposes of example herein, CPU 102 will be designated the master processor. In an embodiment, the master processor need not be permanently assigned such that it can be possible for another CPU to take over status as the master CPU.

Master CPU 102 is permitted to read directly from peripheral device 108 at 204, but any data read by master CPU 102 will be “snooped” and automatically written into FIFO 110 at 206 in an embodiment. When other processors, such as CPU 104, execute the same read transaction later at 208, these non-master CPUs will be inhibited from reading from peripheral device 108 because the read value could be different from that read by master CPU 102. For example, in an embodiment in which peripheral device 108 comprises a sensor device, a characteristic sensed by peripheral device 108 can change in the time that elapses between a read by master CPU 102 and read by CPU 104. Inhibiting non-master CPUs from reading directly from peripheral device 108 is achieved in an embodiment by a CPU hardware modification of a bus sideband signal related to a master CPU identification tag. This tag indicates to the bus address decoder that the transaction should be diverted from peripheral device 108 to a special slave device which then supplies the snooped read data from FIFO 110. Because it is desired that the instruction stream be identical for each CPU 102 and 104, reading the snooped data from FIFO 110 ensures the read data will be the same for each CPU 102 and 104. In an embodiment, each of CPUs 102 and 104 has a read pointer into FIFO 110 that indicates the current position of the respective CPU in the read instruction sequence. A data value in FIFO 110 can be invalidated and overwritten at 210, after each redundant processor has read the data value.

In an embodiment, the master CPU identification tag mentioned above can also be used to indicate whether a particular CPU is currently operating in a redundant mode. A check can be carried out at 205. If a particular CPU is not operating in redundant mode, system 100 can switch into a mode in which redundant executions are not required, such that FIFO 110 and special bus behavior can be disabled at 212 and data read directly from peripheral device 108 at 214.

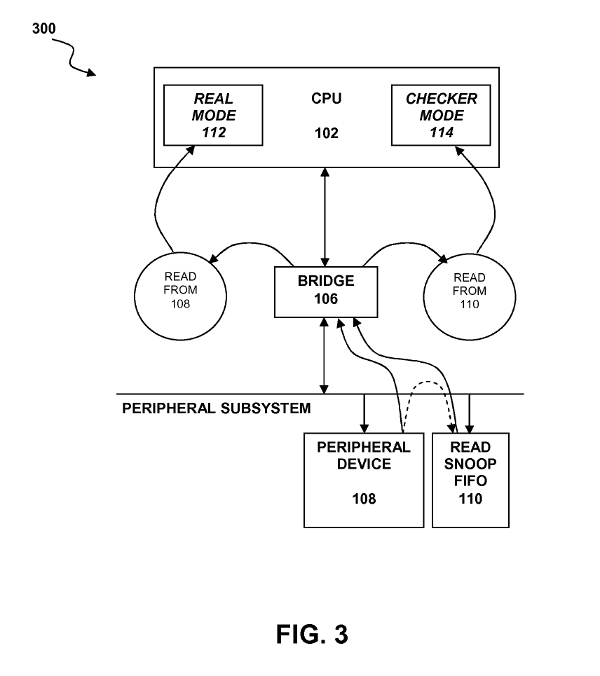

An additional adaptation to system 100 permits system 100 to switch snooping on and off in the context of a single-CPU embodiment. In FIG. 3, system 300 comprises a single CPU 102. CPU 102 operates with temporally separated redundant execution and has two execution modes: a real mode 112 and a checker mode 114. In real mode 112, CPU 102 operates as a master CPU, reading from peripheral device 108. In a subsequent, temporally separated execution, CPU 102 operates in checker mode 114 as a non-master CPU with the special bus behavior described above in order to read from FIFO 110. The code executing in modes 112 and 114 is identical, and a sideband tagging signal is implemented to indicate whether CPU 102 is operating in mode 112 or mode 114. Thus, read mode 112 and checker mode 114 of CPU 102 each get the same data originating from peripheral device 108, and the same sequence of instructions are executed. The embodiment of FIG. 3 can therefore provide a less expensive implementation without sacrificing a significant level of safety.

Turning to the writing of data to peripherals in multi-processor systems, conventional systems typically run multiple processors in lock-step with only one processor coupled to the peripheral device to which data is written. In such a configuration, a comparison of redundant write data is limited to that processor and does not cover transfer of the data through intermediate infrastructure. For this and other reasons, an increased risk of common cause failures affecting multiple processors exists in such systems. Drawbacks also exist in single-processor systems, such as the need to modify write addressing in subsequent executions.

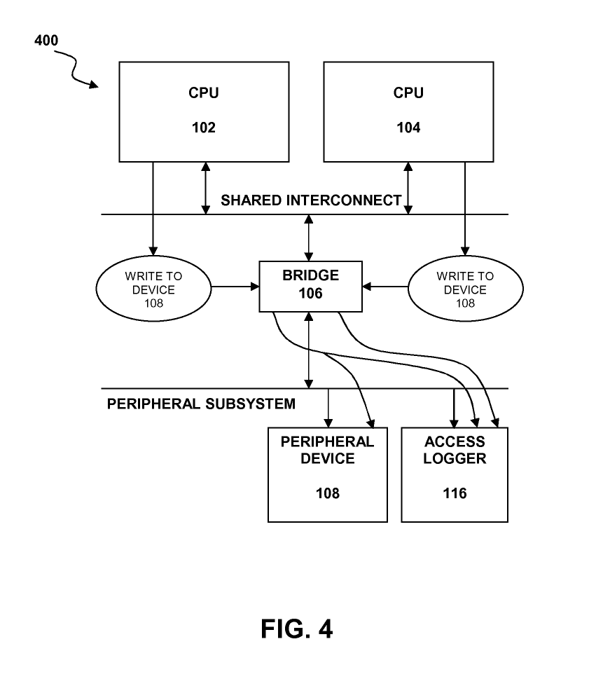

Referring to FIG. 4, embodiments also enable writing to peripheral devices while avoiding drawbacks associated with conventional single- and multi-processor safety systems. System 400 is similar to system 100 discussed above and comprises processors 102 and 104, though any number of parallel processors can be used in other embodiments. Also similar to system 100, CPUs 102 and 104 execute identical code sequences in operation. In contrast with convention systems, CPU 104 generates separate bus transactions to peripheral device 108, and a logger device 116 records these transactions and provides the capability to check that the transactions from each of CPU 102 and CPU 104 are identical when they reach the peripheral subsystem.

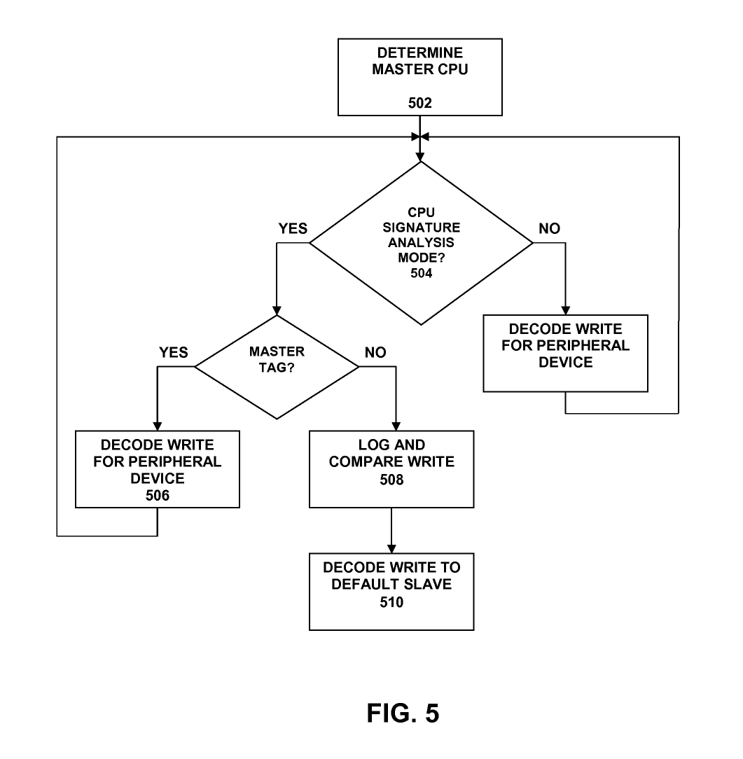

As in system 100, the instructions executed by CPUs 102 and 104 in system 400 must be identical. In contrast with conventional lock-step approaches, however, the instruction executions by respective processors can be temporally separated. In system 400, and referring also to FIG. 5, multiple redundant writes by parallel processors to peripheral device 108 are temporally separated, with one identified as a “master transaction” by a bus sideband signal. One of the processors is designated the master at 502. For purposes of example, CPU 102 will be designated master CPU 102.

In an embodiment, new codes are used for existing flexible peripheral interface (FPI) master identification tag fields sent alongside FPI address phases. These new codes can include a CPU number and whether the CPU is currently operating in a signature analysis mode, which can be determined at 504. A bus address decoder is modified such that in signature analysis mode, only data writes with a specific CPU tag (i.e., the master tag) will be decoded for peripheral device 108 at 506. Data writes with other tags (i.e., data originating from a CPU other than master CPU 102) are still logged by logger 116 and compared at 508 but decoded to select a default slave at 510 that returns a null response.

In another embodiment, data writes are checked using FIFO 110, similar to as described with respect to data reads and FIG. 1, instead of using access logger 116. Access logger 116 and system 400, may provide advantages with respect to overall simplicity compared with a write data embodiment using FIFO 110.

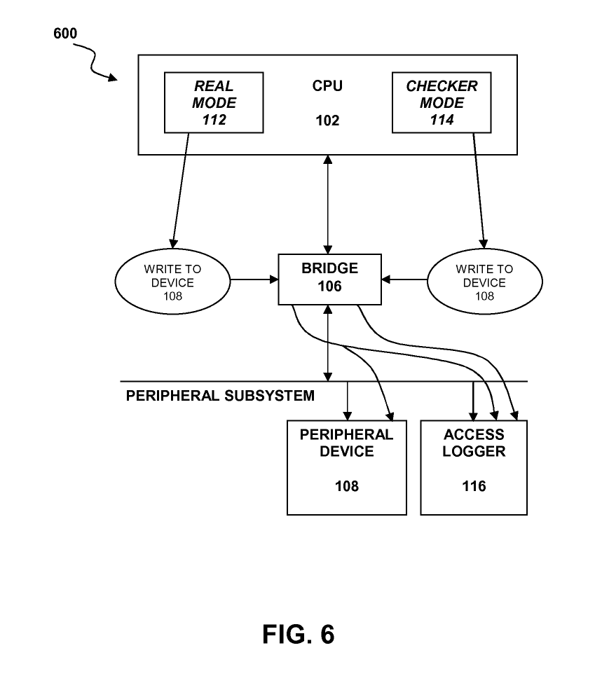

Similar to system 300, system 400 can also be adapted such that the logger feature is enabled and disabled. Referring to FIG. 6, this enables single-processor embodiments. In system 600, CPU 102 has two operating modes that execute redundantly and temporally separated: real mode 112 and checker mode 114. In real mode 112, CPU 112 writes to peripheral device 108, and write data is logged in logger 116. In a subsequent execution in checker mode 114, write data generated by or originating from CPU 102 is checked against the write data from real mode 112 logged in logger 116 to ensure a match. In system 600, the decode masking described above with reference to FIG. 4 can be switched on and off independently of the state of the signature analysis mode.

Embodiments therefore provide several beneficial aspects, including the opportunity to ascertain that identical read transactions from redundant execution runs have reached a peripheral subsystem and to ensure that read data that reaches CPUs is identical for each redundant execution (i.e., that the read data is derived from a single read of a peripheral device). On the write side, embodiments provide the opportunity to ascertain that identical write transactions from redundant execution runs have reached the actuator peripheral subsystem and ensure that the actuator peripheral device itself responds only to one write transaction, with redundant write transactions ignored. Implicit checking, via redundancy, of the entire data read and write paths in both directions between the peripheral subsystem and the processor(s) is thus provided in embodiments without necessitating special code preparation.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, implantation locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method comprising:
reading data from a peripheral device by a first processor;
copying the data to a register;
diverting a read attempt of the peripheral device by a second processor to the register; and
reading the data from the register by the second processor.

2. The method of claim 1, further comprising identifying the first processor as a master processor.

3. The method of claim 2, further comprising determining whether to divert a read attempt of the peripheral device to the register based on presence or absence of a master processor tag.

4. The method of claim 1, wherein copying the data comprises copying the data to a first in first out (FIFO) register.

5. The method of claim 1, further comprising executing identical processing sequences by the first processor and the second processor.

6. The method of claim 5, further comprising executing temporally separated identical processing sequences by the first processor and the second processor.

7. The method of claim 1, further comprising overwriting the data copied to the register.

8. The method of claim 1, further comprising disabling the register to operate in a non-redundant mode.

9. The method of claim 1, wherein the first processor comprises a first operating mode of a processing unit and the second processor comprises a second operating mode of the processing unit, and wherein the first operating mode and the second operating mode are executed with temporal separation by the processing unit.

10. The method of claim 9, further comprising selecting the first operating mode or the second operating mode of the processing unit based on a sideband tagging signal.

11. The method of claim 1, further comprising:
writing data to the peripheral device by the first processor;
logging the data write by the first processor by a logger device;
attempting to write data to the peripheral device by the second processor;
logging the data write by the second processor by the logger device; and
decoding the data write by the second processor to a non-output-generating peripheral device.

12. A method comprising:
writing data to a peripheral device by a first processor;
logging the data write by the first processor by a logger device;
attempting to write data to the peripheral device by a second processor;
logging the data write by the second processor by the logger device; and
decoding the data write by the second processor to a non-output-generating peripheral device.

13. The method of claim 12, further comprising identifying the first processor as a master processor.

14. The method of claim 13, further comprising determining whether to write data to the peripheral device or to the non-output-generating peripheral device based on presence or absence of a master processor tag.

15. The method of claim 12, further comprising executing identical processing sequences by the first processor and the second processor.

16. The method of claim 15, further comprising executing temporally separated identical processing sequences by the first processor and the second processor.

17. The method of claim 12, further comprising comparing write data from the second processor with write data from the first processor.

18. The method of claim 12, wherein the first processor comprises a first operating mode of a processing unit and the second processor comprises a second operating mode of the processing unit, and wherein the first operating mode and the second operating mode are executed with temporal separation by the processing unit.

19. The method of claim 12, further comprising:
reading data from a peripheral device by a first processor;
copying the data to a register;
diverting a read attempt of the peripheral device by a second processor to the register; and
reading the data from the register by the second processor.

20. A system comprising:
at least two processors, wherein one of the at least two processors is a master processor;
a peripheral device configured to be read from and written to by at least one of the at least two processors;
a register configured to copy a data read of the peripheral device by the master processor and provide the data read to another of the at least two processors in response to a diverted peripheral device read attempt by the another of the at least two processors;
an access logger configured to log a data write to the peripheral device by the master processor and compare the data write to a data write of another of the at least two processors; and
a null response peripheral device configured to receive redirected data writes from the another of the at least two processors.

21. The system of claim 20, wherein the peripheral device comprises a sensor or a memory device.

22. The system of claim 20, wherein the register comprises a first in first out (FIFO) register.

23. A system comprising:
a processor having a first mode of execution and a second mode of execution;
a peripheral device configured to be read from and written to by the processor during the first mode of execution;
a register configured to copy a data read of the peripheral device by the processor in the first mode of execution and provide the data read to the processor in the second mode of execution in response to a read request;
an access logger configured to log a data write to the peripheral device by the processor in the first mode of execution and compare the data write to a data write of the processor in the second mode of execution; and
a null response peripheral device configured to receive redirected data writes from the processor in the second mode of execution.

24. The system of claim 23, wherein instructions executed in the first and second modes of execution are identical.

25. The system of claim 23, wherein the peripheral device comprises a sensor or a memory device.
